(19) United States
(12) Patent Application Publication
(10) Pub. No.: US 2014/0284992 A1
(43) Pub. Date: Sep. 25, 2014

(54) Dual seat belt

(71) Applicant: Antonio Chambers, Las Vegas, NV (US)

(72) Inventor: Antonio Chambers, Las Vegas, NV (US)

(21) Appl. No.: 11/183,257

(22) Filed: Mar. 20, 2013

(51) Int. Cl. B60R 22/12

(52) U.S. Cl. CPC B60R 22/12
USPC 297/484

(57) ABSTRACT

This invention relates to improvements in safety Seat Belt, and seat Belt devices for drivers and passengers of vehicles, the invention being particularly designed to be applied to various vehicles for securing and retraining the driver and or passengers from being injured in case of a accident, collision, or crash of any kind and adapted to be applied to the seats of various vehicles, such occupants of automobiles, buses, trucks, trains, airplanes, Race cars, and is a continuation in part of my prior application for dual seat belt. Observation, study, and being catastrophic injured myself in a automobile accident has led me to the conclusion that a large number of injuries and fatalities could be avoided if proper safety devices are placed on the seats of vehicles, and persons using the seat utilize the safety devices. (Dual Seat Belt). Why being well known, when a vehicle is in a collision the vehicle may stopped, but the tendency of the body of a occupant is to move forward and crash through the windsheild, etc, or against some other object causing injury or fatality. I believe from experience that there is no more effective way to minimize injuries and fatalities

This invention relates to improvements in safety Seat Belt, and seat Belt devices for drivers and passengers of vehicles, the invention being particularly designed to be applied to various vehicles for securing and retraining the driver and or passengers from being injured in case of a accident, collision, or crash of any kind and adapted to be applied to the seats of various vehicles, such occupants of automobiles, buses, trucks, trains, airplanes, Race cars, and is a continuation in part of my prior application for dual seat belt.

Observation, study, and being catastrophic injured myself in a automobile accident has led me to the conclusion that a large number of injuries and fatalities could be avoided if proper safety devices are placed on the seats of vehicles, and persons using the seat utilize the safety devices. (Dual Seat Belt). Why being well known, when a vehicle is in a collision the vehicle may stopped, but the tendency of the body of a occupant is to move forward and crash through the windsheild, etc, or against some other object causing injury or fatality. I believe from experience that there is no more effective way to minimize injuries and fatalities resulting from accidents than by furnishing proper safety devices for said vehicles. To that end, it has been object of my invention to provide safe devices such as straps and other similar devices which will effectively limit or almost stop the movement of the occupant or occupants of a vehicle which is stopped in a collisions as to prevent or minimize injury to the occupants or occupants.

Another object has been to provide safety devices of this kind which may be easily utilized and which may be adjusted and which may be arranged out of the when not in use.

Another object has been to provide safety devices which are inexpensive to produce and simple to attach and install.

These and other objects and advantages will appear more fully in the hereinafter specification when in connection with the accompanying drawings, which;

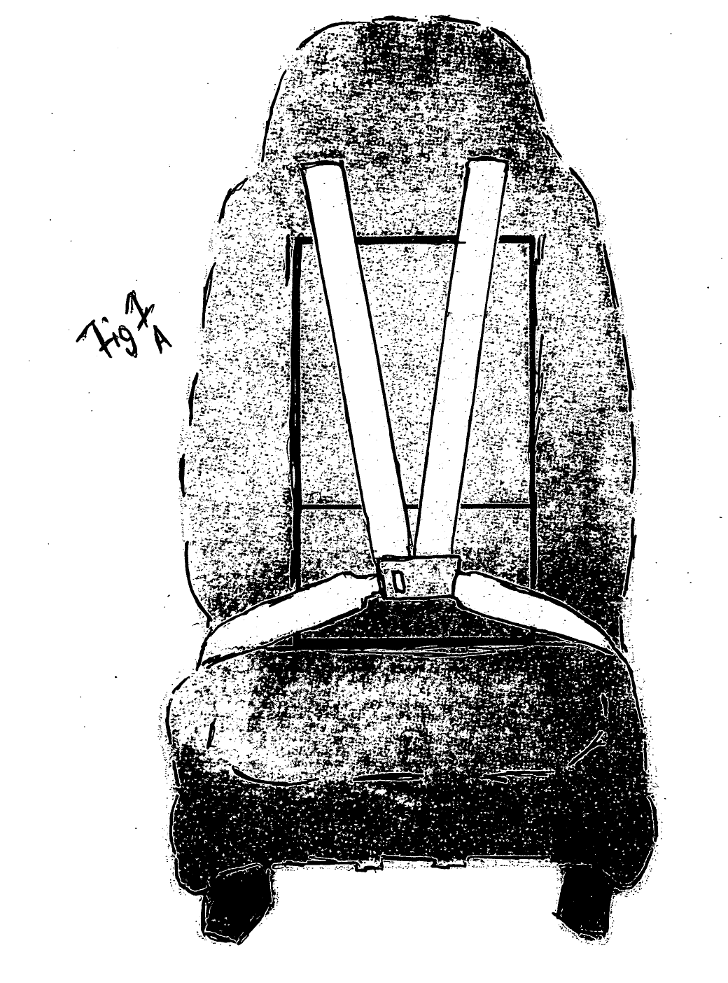

FIG. 1 is a front view of seat showing one form of safety device applied thereto.

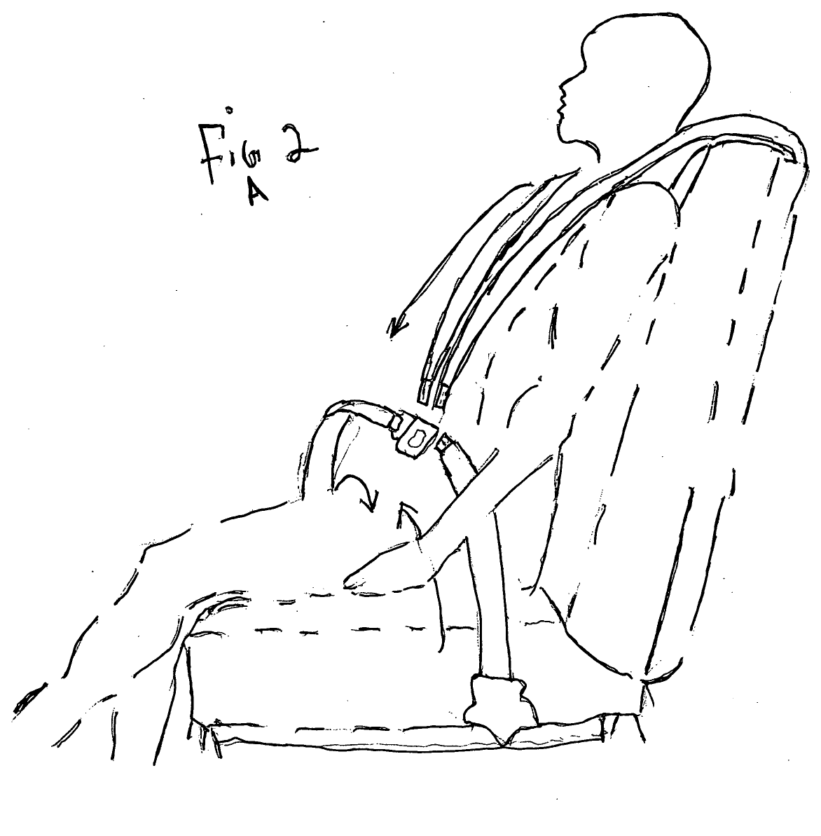

FIG. 2 is a side view of the same;

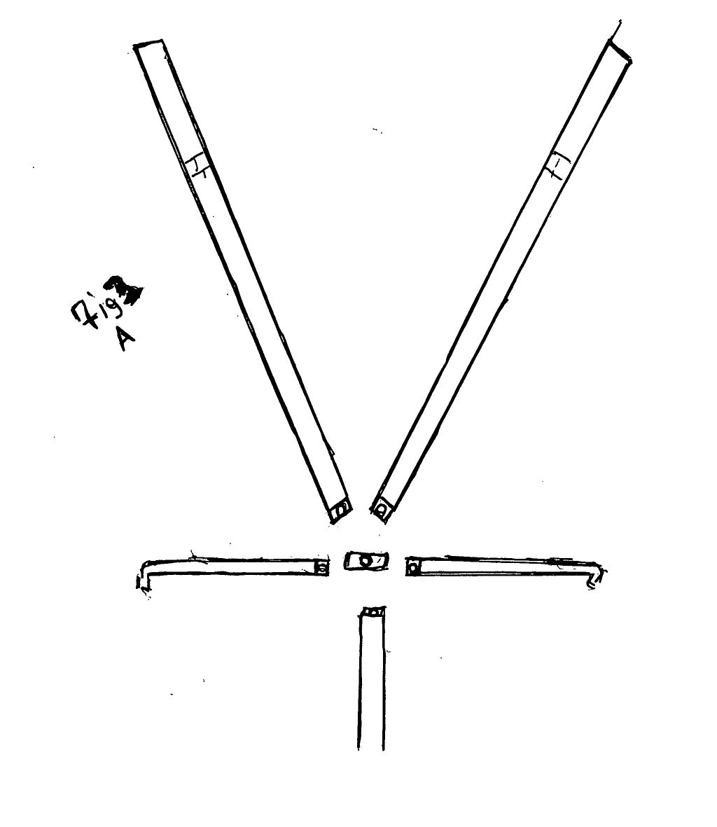

FIG. 3 is a front of a modified form of straps, 4 points and 5 points;

Referring more particularly to the drawings and especially to FIGS. 1 and 2 I show a conventional seat, 13 of an automobile with a 4 point bracket 11 at the bottom of the seat, connecting 11 and 13a pair of 12 straps are secured at one end each of the 11 bracket and these straps are provided with a strap adjustment 15. The straps 12 at their free ends adapted to be secured buckles 9 and 10 to the free end of straps 7 and strap 8 and buckle 9 and 10 which come together to close straps 12 into 9 and 10 buckles and straps 12 and 7 and 8 are mounted to the bracket 14 into the floor mounts 1 and 2 and 3 and 4 of the vehicle or at any point in the front of the seat or the seats themselves at the lower portions thereof. Where the device is applied to individual or single seats, or to the ends of a long seats, recesses 5 may be provided in the seat preferably at the sides and front corners thereof to accommodate the straps 5 and 6. It will also be understood that the device is adaptable for front and back seats and when in use, the straps 12 and 7 and 8 are connected by 9 and 10 form Dual Seat Belt. Then the body of a person reposed on the seat it will thus be seen that when this invention is in use a person takes a seat and the straps 12 and 7 and 8 secures the occupant, which also may be disconnected at the buckle 17 one push release all. The buckles 12 are adjusted to secure the desired adjustment for comfort and proper retention of the person seated. It will also be seen that a person may take a seat in a automobile for example and adjust the straps 12 over the shoulders and connect the same to straps 7 and 8 at the buckle 17 so as extend across the person body or with straps 12 initially connected to the straps 7 and 8 at the buckles 9 and 10 straps connecting may be made at the buckles 9 and 10. In the either event, the necessary lengthwise adjustment of the straps 12 and 7 and 8 may be obtained to the buckles 9 and 10 and 17 so as to properly fit the body.

FIG. 3 In the form of the invention disclosed in which may also be utilized for the front and back seats it will be understood that the straps 12 and 7 and 10 and 9 are secured by bracket 14 and floor mount in this arrangement the strap 12 is passed through the ring 15 of the strap 12 and thence downwardly and at its end is buckle at 9 and 10 and 13 to the strap land 8 thus it will be seen that a person may after being seated, or even before being seat, insert there body into the opening of the seat 17 and may then either buckle strap 9 and 10 and 7 and 8 to 13 if this has been unbuckled and obtain the proper adjustment to properly secure the body, or may buckle 13 to close and secure the same front and back seats. Also it will be understood that the invention is not limited to use the buckles shown or to buckles at all and other equivalent means may be substituted for fastening or adjustment. Also it will be seen that when the invention is used, a person takes his seat and straps 12 and 9 and 10 and 7 and 8 may be drawn over the shoulders with the body projected between the same and the point of crossing the straps at the body and the latter adjust and desired. Also the straps may be adjusted at their connection with the straps 12 and 9 and 10 and 7 and 8 to any length desired to suit different persons according to their sizes or desires in order to secure proper comfort. Also adjusted as desired to properly fit the body without unnecessarily restraining the seated person so that different persons may be secured in the position and held safely against injury or fatality in case of a rollover, accident or collision. The same is true where all straps are used as shown in FIGS. 1. 2, and 3 in connection with 13 it is also to be understood that the front seat and the 4 or 5 straps as seen in FIG. 1 provide for the rear the seat also, that is two for each person seated. Also its to be understood that the straps 12 and 9 and 7 and 12 and 10 and 8 and may after extending over the back seat, be mounted to the floor mount of the vehicle and door floor mount as described in connection with the straps all. The idea is to firmly anchor or mount the straps so that if the seat is torn loose by force of inertia in case of impact, rollover, collision in a accident the passenger will be held to seat and interior of the vehicle independently of the seat and the seat held in position as well, so that the passenger will not be thrown or bashed against an unyielding part of the vehicle or crushed. Also it will be understood that a sensor will be optional, that if the occupants are not buckled up the vehicle will not start.

While I have illustrated and described the preferred form of construction for carrying my invention into effect, this is capable of variation and modification without departing from the spirit of my invention. I, therefore, do not wish to be limited to the precise details of construction set forth, but desire to avail myself of such variations and modifications as come within scope of the appended claims.

Having thus described my invention, what I claim as new and desire to secure by Letters Patent is:

1. In a safety device of the kind described for the seat of a vehicle, a straps disposed incline position to extend over the seat in front of the seat back and
over the top latter and secured at two ends in back of the seat back, mounting means for securing the other end of said straps to the floor of said vehicle adjacent the front of the seat, a second strap secured at door floor mount extend over the waist in front of the seat front to form the connection of the other side, which a person is adapted to insert their body, said straps being adapted to extend across the waist of a person seated in said seat and to limit the movement of said body relative to said seat.

2. In a safety device of the kind described for a seat for a vehicle having a back, has the device of said in one being described, to limit movement of said body relative to said seat.

3. In a safety device of the kind described for a seat of an automobile or similar vehicle, a plurality of straps extending up and down and across in front of seat back for each person, each having its upper end extending over the seat back and across the waist, anchored, mounted in the front and back of said seat having recesses at the front receiving said straps downwardly there through, and means for securing the straps at the lower ends to the bracket, to the floor mount adjacent the base portion of the seat at the front there of. Automobiles will use 4, and 5 points; race cars will use 4,5,6,7, and 8 points; trucks, buses, trains will use 4, and 5 points; airplanes will use 4. 5, points. Antonio Chambers
